(19) United States
(12) Patent Application Publication
(10) Pub. No.: US 2009/0160760 A1
(43) Pub. Date: Jun. 25, 2009

(54) MULTI-FUNCTIONAL PRESENTER

(75) Inventor: Robert Tsao, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: GOOD WAY TECHNOLOGY CO., LTD., Taipei County (TW)

(21) Appl. No.: 11/960,315

(22) Filed: Dec. 19, 2007

(51) Int. Cl. G09G 5/00

(52) U.S. Cl. 345/156

(57) ABSTRACT

A multi-functional presenter includes a case, a control unit in the case, an operating unit on the case and connected to the control unit, a pointer unit connected to the control unit, a bidirectional wireless communication unit connected to the control unit and linked with an external electronic device, a voice receiving unit connected to the control unit for receiving voice signals, a reminding unit connected to the control unit for receiving a warning signal from the external electronic device and giving a reminder to a user, and a power supply unit connected to the control unit. With the voice receiving unit and the bidirectional wireless communication unit, the multi-functional presenter performs not only the functions of paging up/down, pointing images, giving the user a reminder, etc., but also enables on-site voice recording and storing the recorded voice signals on the external electronic device.

### FIELD OF THE INVENTION

The present invention relates to a presenter, and more particularly to a multi-functional presenter that cooperates with a computer to enable on-site voice recording and give a user necessary reminder during a presentation without interfering with the audience.

### BACKGROUND OF THE INVENTION

A conventional wireless presenter generally includes a signal transmitter. A corresponding signal receiver is installed on a computer or a projector for receiving communicating signals sent by the signal transmitter, and transmitting the received signals to the computer or the projector. The signal transmitter includes a control module and a wireless signal transmission circuit for controlling the computer or the projector to move a cursor or page up/down to help a user make a presentation smoothly.

The conventional wireless presenter is designed to control the computer or projector to move the cursor or page up and down without other functions. However, as a matter of fact, a user making the presentation often has other requirements. For example, the user has to control the length of the presentation or record down the questions raised by the audience for reply later. Therefore, the user would usually troublesomely prepare a clock and a small recorder, or install a memory card on the wireless presenter. However, the user concentrating on making the presentation might forget to watch the clock, and the memory card has only limited storage capacity to allow relatively short time of recording. Therefore, the conventional wireless presenter provides only a few simple functions and is not convenient and practical for use.

### SUMMARY OF THE INVENTION

A primary object of the present invention is to provide an improved multi-functional presenter that not only performs the functions of paging up/down, pointing images, giving the user necessary reminder, etc., but also enables on-site voice recording and storing recorded voice signals on an external electronic device, so that the presenter is more convenient and practical for use.

To achieve the above and other objects, the multi-functional presenter according to the present invention includes a case; a control unit provided in the case; an operating unit provided on a front surface of the case and electrically connected to the control unit; a bidirectional wireless communication unit provided in the case and electrically connected to the control unit for linking with an external electronic device; a voice receiving unit provided on the front surface of the case and electrically connected to the control unit for receiving voice signals and allowing the received voice signals to be transmitted via the bidirectional wireless communication unit to the external electronic device; a reminding unit provided in or on the case and electrically connected to the control unit for receiving a warning signal from the external electronic device via the bidirectional wireless communication unit; a pointer unit including a light source and a switch for controlling the on/off of the light source, both of which being provided on the front surface of the case; and a power supply unit provided in the case for supplying electric power to the control unit and the pointer unit.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a multi-functional presenter according to a preferred embodiment of the present invention;

FIG. 2 is a block diagram showing the configuration of the multi-functional presenter of the present invention; and

FIG. 3 shows the use of the multi-functional presenter of the present invention to make a presentation.

### DETAILED DESCRIPTION OF THE PREFERRED EMBODIMENTS

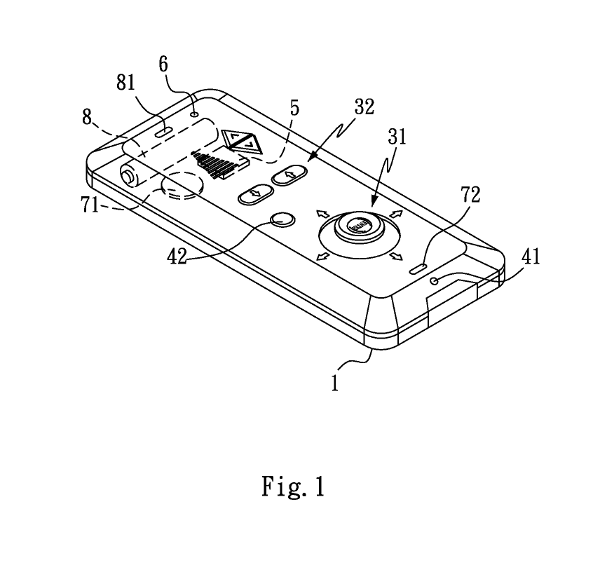

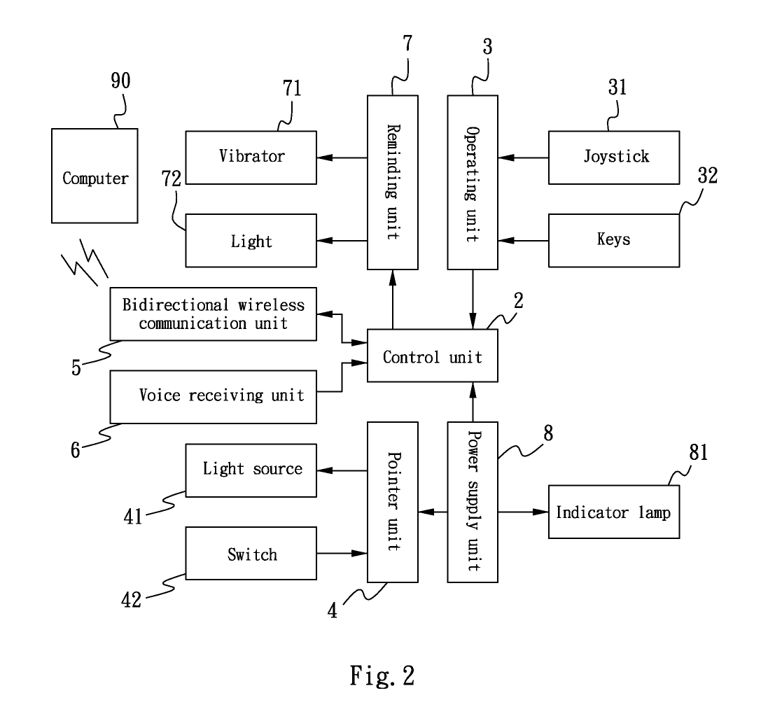

Please refer to FIGS. 1 and 2 that are perspective view and block diagram, respectively, of a multi-functional presenter according to an embodiment of the present invention. As shown, the multi-functional presenter of the present invention includes a case 1, a control unit 2, an operating unit, 3, a pointer unit 4, a bidirectional wireless communication unit 5, a voice receiving unit 6, a reminding unit 7, and a power supply unit 8.

The case 1 may be made of a metal material or a non-metal material, and has a configuration meeting the ergonomics for a user to hold it comfortably.

The control unit 2 is provided inside the case 1.

The operating unit 3 is provided on a front surface of the case 1 and is electrically connected to the control unit 2. The operating unit 3 includes a joystick 31 and a plurality of keys 32.

The pointer unit 4 includes a light source 41 provided at one end of the case 1, and a switch 42 provided on the front surface of the case 1.

The bidirectional wireless communication unit 5 is electrically connected to the control unit 2 and may be a Bluetooth interface or other bidirectional wireless communication interface.

The voice receiving unit 6 is electrically connected to the control unit 2, and may be a microphone provided on one surface of the case 1.

The reminding unit 7 is electrically connected to the control unit 2, and includes a vibrator 71 and a light 72 provided on the front surface of the case 1.

The power supply unit 8 supplies electric power to the control unit 2 and the pointer unit 4, so that power may be supplied to all other units in the presenter for them to work. The power supply unit 8 is electrically connected to an indicator lamp 81 provided on the front surface of the case 1.

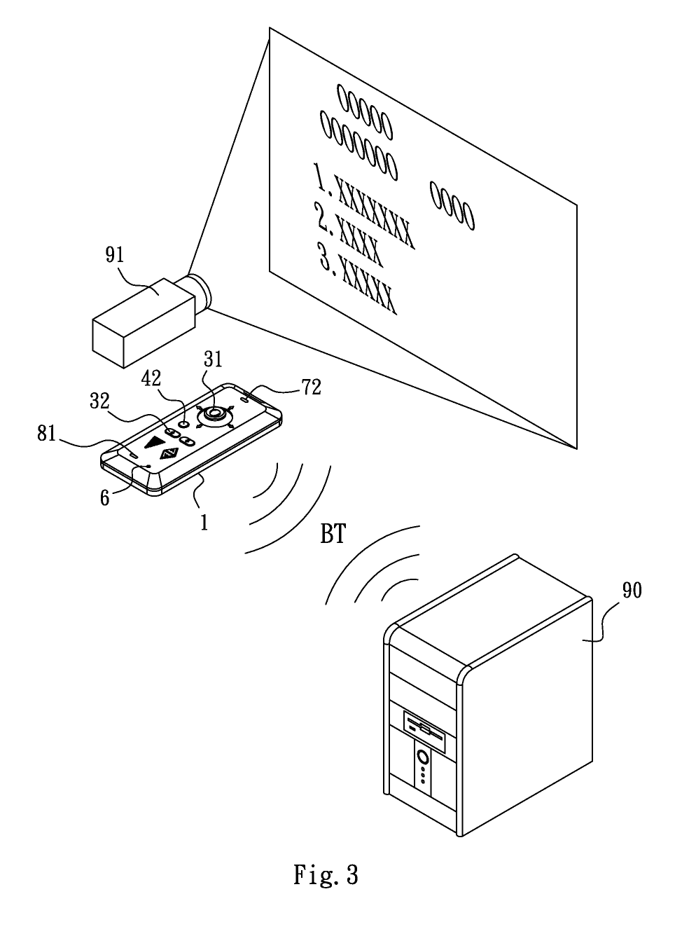

Please refer to FIG. 3 that shows the use of the multi-functional presenter of the present invention to make a presentation. Before using the multi-functional presenter of the present invention, first link it with a required computer 90 or other external electronic device via the bidirectional wireless communication unit 5, which may be a Bluetooth interface. The computer 90 is pre-provided with related driver and operating software for driving or operating the voice receiving unit 6 and the reminding unit 7. Therefore, a user may utilize the linked computer 90 to set different reminding conditions, such as the length of time allowed for making the presentation, so that the vibrator 71 and/or the light 72 of the reminding unit 7 may driven by a warning signal transmitted from the computer 90 to vibrate and/or emit light as a reminder to the user.

The computer 90 is internally provided a voice encoder. When it is desired to record voices on the site of presentation, simply use the voice receiving unit 6 which cooperates with the voice encoder in the computer 90 to convert analog voice signals received by the voice receiving unit 6 into digital voice signals, which are then compressed before being transmitted to the computer 90 via the bidirectional wireless communication unit 5. With related software and storage hardware pre-provided in the computer 90, the digital voice signals from the voice receiving unit 6 are stored on the computer 90 in a music format that could be played via the computer 90. Therefore, the purpose of on-side voice recording is achieved. Since the computer 90 has storage hardware with relatively large storage capacity, the user may have plenty of time for voice recording on the site of presentation.

To use the multi-functional presenter of the present invention in making presentation, simply operate the joystick 31 and the plurality of keys 32, so that the operating unit 3 cooperates with the control unit 2 and the bidirectional wireless communication unit 5 to transmit an actuating signal for controlling a projector 91 or other audio/visual output device to perform different movements, such as moving a cursor, paging up and down, confirmation, etc. When the user makes a presentation with a projector 91, simply push the switch 42 of the pointer unit 4, so that the light source 41 located at one end of the case 1 emits a light beam, which may be directed by the user to point a relevant image.

In the multi-functional presenter of the present invention, there is included a bidirectional wireless communication unit that not only serves as a human-machine interface, but also enables the incorporation of a voice recording function into the presenter, so that the multi-functional presenter of the present invention may also be used in voice transmission. That is, the present invention not only provides the functions of a general wireless presenter, but also the function of a wireless microphone to enable on-site voice recording.

With the above arrangements, the multi-functional presenter of the present invention effectively improves the conventional presenters to not only perform the functions of paging up/down, pointing images, and giving necessary reminder to the user making the presentation, but also use the voice receiving unit and the bidirectional wireless communication unit to record voice on site and store the recorded voice in an external electronic device, making the multi-functional presenter very convenient and practical for use.

What is claimed is:

1. A multi-functional presenter, comprising:
a case;
a control unit being provided inside the case;
an operating unit being provided on a front surface of the case and electrically connected to the control unit;
a bidirectional wireless communication unit being provided in the case and electrically connected to the control unit for linking with at least one externally electronic device;
a voice receiving unit being provided in the case and electrically connected to the control unit for receiving voice signals, so that the received voice signals are transmitted via the bidirectional wireless communication unit to the external electronic device;
a reminding unit being provided in or on the case and electrically connected to the control unit for receiving a warning signal from the external electronic device via the bidirectional wireless communication unit;
a pointer unit having a light source and a switch for controlling the on/off of the light source, and both of the light source and the switch being provided on the front surface of the case; and
a power supply unit being provided in the case for supplying electric power to the control unit and the pointer unit.

2. The multi-functional presenter as claimed in claim 1, wherein the operating unit includes a joystick and a plurality of keys.

3. The multi-functional presenter as claimed in claim 1, wherein the bidirectional wireless communication unit is a Bluetooth interface.

4. The multi-functional presenter as claimed in claim 1, wherein the voice receiving unit is a microphone.

5. The multi-functional presenter as claimed in claim 1, wherein the reminding unit includes a vibrator arranged in the case and/or a light arranged on the front surface of the case, and the vibrator and/or the light are/is driven by the received warning signal to vibrate and/or emit light.

6. The multi-functional presenter as claimed in claim 1, wherein the power supply unit is electrically connected to an indicator lamp provided on the front surface of the case.
